(19) United States
(12) Patent Application Publication
(10) Pub. No.: US 2012/0148454 A1
(43) Pub. Date: Jun. 14, 2012

(54) PATTERNED COMPOSITE LIGHT HARVESTING STRUCTURES AND METHODS OF MAKING AND USING

(75) Inventors: Ronald Lee Koder, Brooklyn, NY (US); David Thomas Crouse, New York, NY (US)

(73) Assignee: Research Foundation of the City University of New York, New York, NY (US)

(21) Appl. No.: 13/264,682

(22) PCT Filed: Apr. 16, 2010
(86) PCT No.: PCT/US10/31472

§ 371 Date: Feb. 24, 2012

Related U.S. Application Data
(60) Provisional application No. 61/212,877, filed on Apr. 17, 2009.

(51) Int. Cl. B01J 19/08; B05D 5/12; B05D 5/06; B82Y 40/00; B82Y 30/00

(52) U.S. Cl. 422/186; 427/74; 977/734; 977/742; 977/932; 977/890

(57) ABSTRACT

A light harvesting arrangement includes a conductive layer defining a plurality of cavities through the conductive layer. Each cavity has a lateral cross-sectional dimension in a range of 25 nanometers to 3000 nanometers and the cavities are configured and arranged to preferentially capture light in a wavelength band. The light harvesting arrangement also includes a light utilizing material disposed on the walls of the cavities or within one or more light receiving structures that receives light from the cavities (or both). The light utilizing material is configured and arranged to absorb light captured by the cavities.

### CROSS REFERENCE TO RELATED APPLICATIONS

The present application claims the benefit of U.S. Provisional Patent Application Ser. No. 61/212,877, filed on Apr. 17, 2009, the contents of which are hereby incorporated by reference in their entirety.

### FIELD

The present invention is directed to patterned composite structures for light harvesting and methods of making and using the structures. The present invention is also directed to patterned composite structures that utilize properties of one or more of surface plasmons, plasmonic crystals, and optical cavity modes to provide light to light utilizing materials.

### BACKGROUND

A century of study of photosynthetic organisms has resulted in an in-depth molecular-level understanding of the design features allowing efficient conversion of solar to chemical energy by complexes of antenna and reaction center proteins embedded in a membrane. A systemic analysis of these data led in the late 1980s to the bioinspired concept of ‘integrated modular assembly’ as a simple basis for constructing molecular devices, constructed of any nanoscale material capable of holding the active elements at fixed distances, which can transform photonic energy into vectorial electron transfer. Since then, there have been many published instances of synthetic molecular constructions that can perform the task of long-lived light induced charge separation and vectorial electron transfer. These have been attached to electrodes to create photovoltaic cells and set up to drive redox reactions such as the hydrolysis of water.

### BRIEF SUMMARY

One embodiment is a light harvesting arrangement including a conductive layer defining a plurality of cavities through the conductive layer. Each cavity has a lateral cross-sectional dimension in a range of 25 nanometers to 3000 nanometers and the cavities are configured and arranged to preferentially capture light in a wavelength band. The light harvesting arrangement also includes a light utilizing material disposed on the walls of the cavities and configured and arranged to absorb light captured by the cavities.

Another embodiment is a light harvesting arrangement including a conductive layer defining a plurality of cavities and a plurality of light receiving structures in the conductive layer. Each cavity has a lateral cross-sectional dimension in a range of 25 nanometers to 3000 nanometers and the cavities are configured and arranged to preferentially capture light in a wavelength band. Each light receiving structure being positioned to receive light from one or more of the cavities. The light harvesting arrangement also includes a light utilizing material disposed within the light receiving structures and configured and arranged to absorb light captured by the cavities.

Yet another embodiment is a method of making a light harvesting arrangement. The method includes forming a conductive layer with a plurality of cavities through the conductive layer. Each cavity has a lateral cross-sectional dimension in a range of 25 nanometers to 3000 nanometers and the cavities are configured and arranged to preferentially capture light in a wavelength band. The method also includes forming a light utilizing material on walls of the plurality of the cavities. The light utilizing material is configured and arranged to absorb light captured by the cavities.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic perspective view of one embodiment of a light harvesting arrangement, according to the invention;

FIG. 2 is a schematic perspective view of another embodiment of a light harvesting arrangement, according to the invention;

FIG. 3 is a schematic cross-sectional view of a further embodiment of a light harvesting arrangement, according to the invention;

FIG. 4 is a schematic perspective view of yet another embodiment of a light harvesting arrangement, according to the invention; and

FIG. 5 is a schematic cross-sectional view of one embodiment of a cavity of a light harvesting arrangement, according to the invention.

### DETAILED DESCRIPTION

The present invention is directed to patterned composite structures for light harvesting and methods of making and using the structures. The present invention is also directed to patterned composite structures that utilize properties of one or more of surface plasmons, plasmonic crystals, and optical cavity modes to provide light to light utilizing materials. Plasmonic and photonic crystal properties that can be used in these arrangements to increase efficiency include one or more of optical cavity modes, surface plasmons, Rayleigh anomalies, and diffraction.

One embodiment of the invention is a light harvesting arrangement with multiple cavities (for example, grooves or apertures or both). The cavities are designed to produce surface plasmons, optical cavity modes, or both in a wavelength band of the spectrum (e.g., a band within the infrared, visible, and ultraviolet wavelengths or a wavelength band within the range of 300 nanometers to 3000 nanometers) and direct light within the corresponding wavelength band to the cavities. On the walls of the cavities, or in a portion of the light harvesting arrangement that receives light from the cavity (or both), is disposed at least one light utilizing material. The light utilizing material is selected to efficiently absorb at least a portion of the light in the wavelength band of the corresponding cavity (e.g., the wavelength band that corresponds to surface plasmon modes on the walls of the cavity or optical cavity modes within the cavity) and convert it for use in generating electrical energy, performing chemical reactions, or the like.

The cavities are formed within a conductive layer (for example, a metal film). In at least some embodiments, the cavities have a lateral cross-sectional shape that is circular, elliptical, rectangular, square, “C”-shaped, “L”-shaped, or bowtie-shaped, or any other regular or irregular shape that supports surface plasmon modes on the walls of the cavities or optical cavity modes within the cavity (or both surface plasmon modes and optical cavity modes). In other embodiments, the cavities are grooves in a metal film structure which support surface plasmon modes on the walls of the cavities or optical cavity modes within the cavity (or both surface plasmon modes and optical cavity modes). The cavities can be arranged in any periodic, non-periodic, aperiodic (i.e., repeating, but not perfectly periodic) or random arrangement.

The concentration of incident light in specific locations on, or near, a surface that it patterned or textured in some way has been studied previously. The localization of light in patterned structures has been used for numerous applications including enhanced light sensors, surface enhanced Raman spectroscopy (SERS), photonic circuits and other applications. In SERS, the excitation of surface plasmons at the interface of a metal/air or metal/dielectric interface produces areas of high electromagnetic field intensity near the metal. Any particle, molecule, cell, protein or other entity near the metal/dielectric interface will cause a surface plasmon excitation to occur at a slightly different energy (or wavelength) and or different angle of incidence thereby allowing the detection of the particle.

Localization of light can also be accomplished by the excitation of cavity modes, produced either by localized surface plasmons within cavities or by waveguide modes within cavities, and in such a way that the light is not only confined near the metal/dielectric interface but also in specific areas, i.e., cavities at and near the interface. These cavities modes are produced from incident light when the light is repeatedly and resonantly reflected back and forth in the cavity (which may be closed at one end or neither end). In the case of the excitation of cavity modes, the electromagnetic energy, supplied by the incident light, is highly localized within the cavities. Characteristics of light localization via cavity modes are different compared to light localization via surface plasmon because surface plasmons only localize light near an interface but generally not in specific areas on the interface. In fact, the electromagnetic field intensities from surface plasmons are generally highly de-localized on the interface, existing everywhere on the interface.

The arrangements described herein utilize light controlling and channeling features of plasmonic and photonic crystals that can provide, at least in some embodiments, arrangements that split incoming light according to wavelength and efficiently channel these separate wavelength bands into absorbing cavities. The cavities can use light channeling or “light whirlpool” plasmonic crystal effects associated with the cavities to efficiently concentrate light of different wavelength bands into separate horizontally distributed absorbers.

Although not wanting to be bound by any particular theory, it is believed that in at least some embodiments, the surface plasmon or optical cavity modes generate resonance effects that channel light of a particular wavelength band to the cavity based, at least in part, on the size of the cavity (e.g., the lateral cross-sectional dimension or dimensions of the cavity; the depth of the cavity; or a combination thereof.) The light whirlpool effect of plasmonic crystals can produce strong light concentration in the cavities allowing for 30%-100% of the light of separate wavelength bands to be channeled into and absorbed within a small volume of light utilizing material.

In at least some embodiments, different wavelength bands of the spectrum are split and horizontally diverted to different sets of cavities that are distributed along the surface of the device. The different cavities are designed to relatively efficiently convert the optical energy of different wavelength bands.

Light of different wavelengths can be channeled and concentrated in cavities that have different lateral cross-sectional dimensions (e.g., different diameters, different major or minor diameters, different lengths or breadths, or the like.) The optical modes responsible for this effect are typically optical cavity modes (CMs) or surface plasmon modes or both. These modes and their light channeling and concentrating abilities have been demonstrated both analytically and experimentally as described in, for example, Crouse et al., Phys. Rev. Lett. B, 77(1), T195437T (2008); Crouse et al., Appl. Phys. Lett., 92, 191105 (2008); Crouse et al., Optics Express 20, 7760 (2005); Crouse, IEEE Trans. Electron Devices 52, 2365 (2005); Crouse et al., Opt. Express 14, 2047 (2006); Crouse et al. J. Opt. A: Pure Appl. Opt. 8, 175 (2006); and Crouse et al., Opt. Express 15, 1415 (2007), all of which are incorporated herein by reference. These papers describe examples of methods for determining the wavelength band for a particular cavity analytically or experimentally.

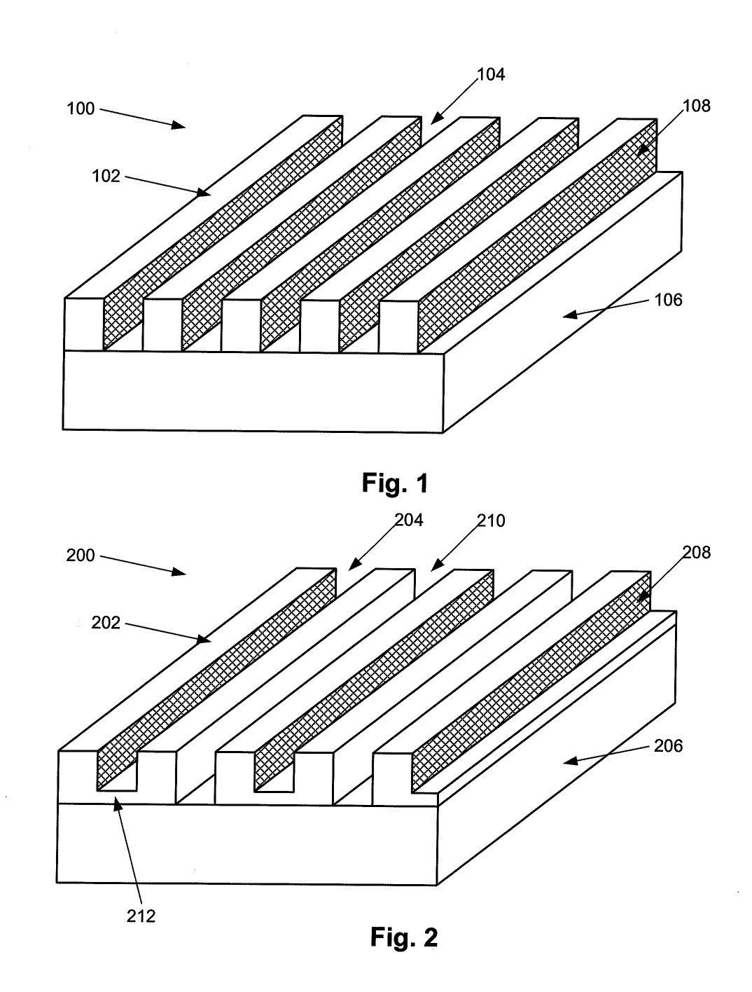

FIG. 1 is a schematic perspective view of one embodiment of a portion of a light harvesting arrangement. The illustrated portion of the light harvesting arrangement 100 includes multiple grooves 104 formed in conductive layer 102. The conductive layer 102 is disposed on a substrate 106. A light utilizing material 108 is disposed on sides of the grooves or on the exposed substrate at the bottom of the grooves (or both).

The conductive layer 102 can be made using any suitable conductive material including, but not limited to, gold, silver, copper, titanium, tungsten, tin, lead, any other metal or alloy, a doped semiconductor (for example, silicon, cadmium telluride, or gallium arsenide), or a conductive oxide (for example, indium tin oxide). The conductive layer typically has a thickness in the range of 50 nanometers to 5 micrometers, although thicker or thinner layers may be used.

The cavities of FIG. 1 are grooves, but it will be recognized that other types of cavities can be used including cavities with any suitable lateral cross-sectional shape, for example, circular (as in FIG. 4), elliptical, rectangular, square, “C”-shaped, “L”-shaped, or bowtie-shaped, or the cavity can be a groove in the metal film. The cavities can have any suitable depth, for example, a depth in the range of 25 nanometers to 3000 nanometers. The cavities can have any suitable lateral cross-sectional dimension, for example, a lateral cross-sectional dimension in the range of 25 nanometers to 3000 nanometers. The lateral cross-sectional dimension or dimensions may correspond to one or more of the following depending on the shape of the cavity: a diameter, a major or minor axis length (or both), a width, or a breadth.

The dimension or dimensions of the cavities (e.g., one or more lateral cross-sectional dimensions or a depth or both) can be chosen to produce surface plasmons on the walls of the cavity or an optical cavity mode within the cavity (or both surface plasmons or optical cavity modes) that acts as a light whirlpool, pulling light (of a certain wavelength band) from areas distant to the cavity into the cavity. These dimensions can vary depending on if surface plasmons or optical cavity modes are used to produce this effect and what material is in the cavity. In at least some embodiments, the cavity has a cross-sectional dimension that is within 100% (or 300% or 200% or 50% or 25% or 10% or 5% or 2% or 1%) of λ/n₁, where n₁ is an index of refraction of the material in the cavity that receives the light and λ is a wavelength in the wavelength band that the cavity is designed to channel. In embodiments with different sets of cavities tuned to different wavelength bands, one or more of the dimensions of the cavities (e.g., a lateral cross-sectional dimension or a depth or both) differ between the sets. For example, one or more of the dimensions (e.g., a lateral cross-sections dimension) of the cavities of one set may be at least 5%, 10%, 25%, 50%, 75%, 100%, 200% or more larger than the corresponding dimension in another set.

The substrate 106 can be made using any suitable material including, but not limited to, glass, quartz, fused silica, silicon, plastic or other polymer material, semiconductor, dielectric, or metal (when electrically isolated from the conductive layer). The substrate may be rigid or flexible. In at least some embodiments, the substrate has a thickness in the range of 50 nanometers to 10 centimeters.

Optionally, one or more layers may be positioned between the substrate 106 and conductive layer 102. These layers may serve a variety of different purposes including, but not limited to, adhesion promotion, electrical contacts, eliminating deleterious reactions or intermixing of materials in the structure, insulator layers, or other purposes. These layers can be of thicknesses in the range of, for example, 0.1 nanometers to 1 centimeter and can be composed of platinum, titanium, tantalum, aluminum, chrome, silicon dioxide, polycrystalline silicon, silicon nitride, copper or any other conductive or insulating materials.

Any suitable light utilizing material 108 can be used. The light utilizing material absorbs the light in the cavity for use in generating an electrical current, producing a chemical reaction, or the like. Preferably, the light utilizing material acts as a reaction center that is responsive to the light in the cavity. The light utilizing material can be particles, molecules, cells, proteins, RNA, DNA, any other biopolymer, and the like. In at least some embodiments, the light utilizing material is formed on the walls of the cavities.

In at least some embodiments, the light utilizing material is an organic compound, organometallic compound or complex, or biomolecule (e.g., a protein). Examples of suitable light utilizing materials include, but are not limited to, ruthenium compounds, osmium compounds, chlorophylls, carotenoids, chlorins, porphyrins, and phthalocyanines. These compounds may be useful for charge separation. Other examples of light utilizing compounds include conductive polymers and ruthenium complexes (e.g., Ru(byp) complexes) for electrical current production; iridium compounds for water splitting; iron, nickel, platinum, or palladium compounds for hydrogen production; iridium or rhenium compounds for nitrogen fixation; nanoparticles for hydrogen or oxygen production; proteins for biofuel or hydrogen production or for nitrogen fixation or water splitting. Other examples include buckminsterfullerenes and carbon nanotubes. Yet other examples include the light-utilizing proteins disclosed in U.S. Provisional Patent Application Ser. No. 61/212,878, entitled “Artificial proteins as a smart matrix for light-initiated charge separation”, incorporated herein by reference. The light utilizing compounds may be provided with other materials, such as a sol gel, to aid in deposition or stabilization. It will be recognized that the light utilizing material may be a single material or a combination of materials.

Within each repeating period there may be one groove or two or more grooves that may have different widths or some other different aspect to them (relative to the other grooves in each repeating period) so that the cavity modes capture different wavelength bands of incident light. Besides the grooves or trenches, the structure can have a patterned substrate with metal or semiconductor electrodes at the base of the grooves that can aid in the deposition of the light utilizing material.

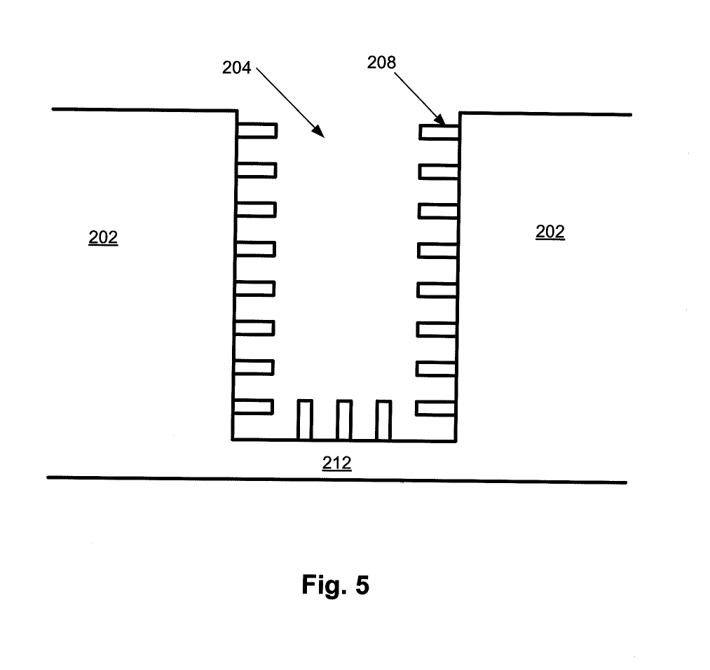

FIG. 2 is a schematic perspective view of another embodiment of a portion of a light harvesting arrangement. The illustrated portion of the light harvesting arrangement 200 includes two different types of grooves 204, 210 formed in conductive layer 202. The conductive layer 202 is disposed on a substrate 206. A light utilizing material 208 is disposed on sides of one type of groove 204 or on the exposed substrate at the bottom of the grooves 204 (or both). A portion 212 of the conductive layer 202 is provided at the bottom of groves 204. This portion can optionally act as an electrode. FIG. 5 is a schematic cross-sectional view of one of the grooves 204. The other type of groove 210 electrically separates the light harvesting arrangement into different sections. This type of groove may be called an isolation groove or trench. It will be understood that the two types of grooves do not need to alternate as illustrated in FIG. 2, but that two, three, four, or more grooves 204 may be positioned between each isolation groove 210.

FIG. 4 is a schematic perspective view of a further embodiment of a portion of a light harvesting arrangement. The illustrated portion of the light harvesting arrangement 400 illustrates two different types of cavities 404, 405 and isolation grooves 410 formed in a conductive layer 402. The cavities 404, 405 are apertures in the conductive layer 402. In the illustrated embodiments, the apertures 404, 405 have a circular cross-section, but apertures with other cross-sections can be used, as described above. The conductive layer 402 is disposed on a substrate 406. A light utilizing material is disposed on sides of the cavities 404, 405. In this embodiment, there are two different types of cavities, but it will be recognized that in other embodiments, the cavities can be the same or there may be three, four, five, six, or more different types of cavities. When there are different types of cavities, the different types may have different dimensions to capture different wavelength bands of light. In some embodiments, the different types of cavities may have different light utilizing materials disposed in the cavities to absorb the different wavelength bands of light. In other embodiments, the light utilizing material of two or more different types of cavities may be the same. Each section separated by an isolation groove from other sections may have cavities of the same type or may have cavities of two or more different types in that section.

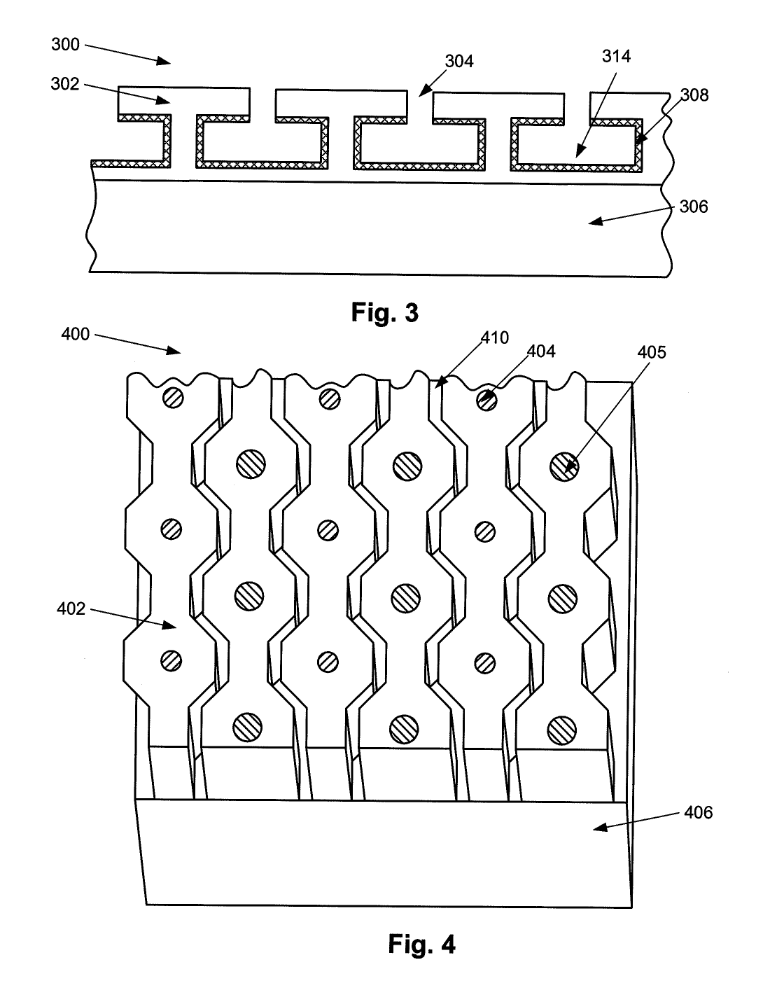

FIG. 3 is a schematic cross-sectional view of yet another embodiment of a portion of a light harvesting arrangement. The illustrated portion of the light harvesting arrangement 300 multiple cavities 304 formed in a conductive layer 302. The conductive layer 302 is disposed on a substrate 306. A light receiving structure 314 is formed in the conductive layer 302 below each cavity 304. A light utilizing material 308 is disposed within the light receiving structure 314 (and optionally on the sides of the cavity 304). This arrangement allows for a larger amount of the light utilizing material to be provided in the arrangement 300. Light captured by the cavity 304 enters the light receiving structure and may reflect within the structure until absorbed by the light utilizing material 308. The light receiving structure may have any suitable shape including the shape of a pillbox, sphere, or the like. The light receiving structure may be used with any type of cavity described above including grooves.

The light harvesting arrangements can be formed using conventional techniques including conventional semiconductor processing methods, such as photolithography, physical or chemical vapor deposition, coating techniques (such as spin coating or dip coating), and the like.

The above specification, examples and data provide a description of the manufacture and use of the composition of the invention. Since many embodiments of the invention can be made without departing from the spirit and scope of the invention, the invention also resides in the claims hereinafter appended.

1. A light harvesting arrangement, comprising:
a conductive layer defining a plurality of cavities through the conductive layer, each cavity having a lateral cross-sectional dimension in a range of 25 nanometers to 3000 nanometers, wherein the cavities are configured and arranged to preferentially capture light in a wavelength band; and
a light utilizing material disposed on the walls of the cavities and configured and arranged to absorb light captured by the cavities.

2. The light harvesting arrangement of claim 1, wherein the wavelength band preferentially captured by the cavities is based, at least in part, on the lateral cross-sectional dimension of the respective cavity, wherein the light of the particular wavelength band excites surface plasmons or optical cavity modes or both in the respective cavity.

3. The light harvesting arrangement of claim 1, wherein the light utilizing material is selected from the group consisting of organic compounds, organometallic compounds and complexes, and biomolecules.

4. The light harvesting arrangement of claim 1, wherein the light utilizing material is selected from the group consisting of compounds of ruthenium, osmium, iridium, iron, nickel, platinum, and palladium.

5. The light harvesting arrangement of claim 1, wherein the light utilizing material is selected from the group consisting of chlorophylls, carotenoids, chlorins, porphyrins, and phthalocyanines, buckminsterfullerenes, and carbon nanotubes.

6. The light harvesting arrangement of claim 1, wherein the light utilizing material is a protein.

7. The light harvesting arrangement of claim 1, wherein each of the cavities has a lateral cross-sectional shape that is circular, elliptical, rectangular, square, “C”-shaped, “L”-shaped, or bowtie-shaped.

8. The light harvesting arrangement of claim 1, wherein each of the cavities is a groove.

9. The light harvesting arrangement of claim 1, wherein the plurality of cavities comprises a plurality of first cavities and a plurality of second cavities, wherein the first cavities are different from the second cavities, wherein the first cavities are configured and arranged to preferentially capture light in a first wavelength band and the second cavities are configured and arranged to preferentially capture light in a second wavelength band.

10. The light harvesting arrangement of claim 1, wherein the conductive layer further defines at least one isolation groove separating sections of the conductive layer.

11. A light harvesting arrangement, comprising:
a conductive layer defining a plurality of cavities and a plurality of light receiving structures in the conductive layer, each cavity having a lateral cross-sectional dimension in a range of 25 nanometers to 3000 nanometers, wherein the cavities are configured and arranged to preferentially capture light in a wavelength band, each light receiving structure being positioned to receive light from one or more of the cavities; and
a light utilizing material disposed within the light receiving structures and configured and arranged to absorb light captured by the cavities.

12. The light harvesting arrangement of claim 11, wherein the light utilizing material is selected from the group consisting of organic compounds, organometallic compounds and complexes, and biomolecules.

13. The light harvesting arrangement of claim 11, wherein the light utilizing material is selected from the group consisting of compounds of ruthenium, osmium, iridium, iron, nickel, platinum, and palladium.

14. The light harvesting arrangement of claim 11, wherein the light utilizing material is selected from the group consisting of chlorophylls, carotenoids, chlorins, porphyrins, and phthalocyanines, buckminsterfullerenes, and carbon nanotubes.

15. The light harvesting arrangement of claim 11, wherein the light utilizing material is a protein.

16. The light harvesting arrangement of claim 11, wherein each of the cavities has a lateral cross-sectional shape that is circular, elliptical, rectangular, square, “C”-shaped, “L”-shaped, or bowtie-shaped.

17. The light harvesting arrangement of claim 11, wherein each of the cavities is a groove.

18. The light harvesting arrangement of claim 11, further comprising the light utilizing material disposed on walls of the cavities.

19. A method of making a light harvesting arrangement, the method comprising:
forming a conductive layer with a plurality of cavities through the conductive layer, each cavity having a lateral cross-sectional dimension in a range of 25 nanometers to 3000 nanometers, wherein the cavities are configured and arranged to preferentially capture light in a wavelength band; and
forming a light utilizing material on walls of the plurality of the cavities, wherein the light utilizing material is configured and arranged to absorb light captured by the cavities.

20. The method of claim 19, further comprising forming at least one isolation groove in the conductive layer to electrically separate sections of the conductive layer.
